(19) United States
(12) Patent Application Publication
(10) Pub. No.: US 2007/0058930 A1
(43) Pub. Date: Mar. 15, 2007

(54) Information processing apparatus, information processing method and program

(75) Inventor: Toru Iwamoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/508,837

(22) Filed: Aug. 24, 2006

(30) Foreign Application Priority Data
Sep. 9, 2005 (JP) 2005-261445

(51) Int. Cl. H04N 5/91

(52) U.S. Cl. 386/83

(57) ABSTRACT

Disclosed herein is an information processing apparatus for controlling an operation that is performed to record a broadcast received by a tuner onto a recording medium, the information processing apparatus including: storage means configured to store a list of recording candidate broadcasts, which are to be recorded onto the recording medium; decision means that, at a recording start time for a particular recording candidate broadcast, which is one of the recording candidate broadcasts in the list, judges whether a tuner is available for recording the particular recording candidate broadcast, and decides whether or not to record the particular recording candidate broadcast; and recording control means configured to record the particular recording candidate broadcast onto the recording medium when a decision is made to record the particular recording candidate broadcast.

### CROSS REFERENCES TO RELATED APPLICATIONS

The present invention contains subject matter related to Japanese Patent Application JP 2005-261445 filed in the Japanese Patent Office on Sep. 9, 2005, the entire contents of which being incorporated herein by reference.

### BACKGROUND OF THE INVENTION

1. Field of the Invention

The present invention relates to an information processing apparatus, information processing method, and program, and more particularly to an information processing apparatus, information processing method, and program for effectively using available tuners.

2. Description of the Related Art

Hard disk recorders and other recording/reproducing apparatuses that can record and reproduce broadcasts (video and audio signals constituting broadcasts) have been remarkably widespread in recent years. Some of them incorporate a plurality of tuners that receive broadcasts, and can simultaneously record a plurality of broadcasts (refer, for instance, to Japanese Patent Laid-Open No. Hei 9-9193).

As the information for programmed recording of a broadcast, the above recording/reproducing apparatuses use EPG (Electronic Program Guide) information or other similar broadcast information (refer, for instance, to Japanese Patent Laid-Open Nos. 2001-313878 and 2001-8122).

FIG. 1 is a flowchart illustrating a programmed recording process that is performed by a recording/reproducing apparatus in the past incorporating a tuner.

When the user operates, for instance, a remote controller for the recording/reproducing apparatus to enter the date and time for desired programmed recording (hereinafter referred to as the recording time), a channel, and other relevant information, the recording/reproducing apparatus performs step S11 to check for a programmed recording clash, that is, judge whether the recording of any other broadcast is already programmed at the entered recording time (in the recording time slot).

If the judgment result obtained in step S11 indicates that there is no programmed recording clash, processing proceeds to step S12. In step S12, the recording/reproducing apparatus registers the entered broadcast and then terminates the process. More specifically, the recording/reproducing apparatus stores the entered recording time, channel, and other relevant information and performs setup so as to record the broadcast on the designated channel at the entered recording time.

If, on the other hand, the judgment result obtained in step S11 indicates that there is a programmed recording clash, processing proceeds to step S13. In step S13, the recording/reproducing apparatus displays an error message to indicate that the entered broadcast cannot be programmed for recording, and then terminates the process.

The process indicated by a flowchart shown in FIG. 2 is performed to record the broadcast programmed as described above (the broadcast programmed for recording). More specifically, the recording/reproducing apparatus performs step S21 to judge whether a recording start time for the broadcast programmed for recording has come, and waits until the recording start time comes.

If the judgment result obtained in step S21 indicates that the recording start time for the broadcast programmed for recording has come, processing proceeds to step S22. In step S22, the recording/reproducing apparatus starts recording the broadcast programmed for recording. When a preselected recording end time (broadcast end time) comes subsequently, the recording/reproducing apparatus terminates a recording operation.

FIG. 3 is a flowchart illustrating a programmed recording process that is performed by a recording/reproducing apparatus in the past incorporating two tuners.

When the user operates, for instance, a remote controller for the recording/reproducing apparatus to enter the date and time for desired programmed recording, a channel, and other relevant information, the recording/reproducing apparatus performs step S31 to judge whether an unused tuner is available during the time slot of the entered broadcast, that is, whether both of the two built-in tuners are programmed for some other broadcasts during the entered recording time slot.

If the judgment result obtained in step S31 indicates that an unused tuner is available, processing proceeds to step S32. In step S32, the recording/reproducing apparatus registers the entered broadcast and then terminates the process. More specifically, the recording/reproducing apparatus stores the tuner to be used as well as the entered recording time, channel, and other relevant information, and performs setup so as to record the broadcast on the designated channel at the entered recording time by using the selected tuner.

If, on the other hand, the judgment result obtained in step S31 indicates that no tuner is available, that is, the two tuners are both scheduled for use during the broadcast time slot of the entered broadcast, processing proceeds to step S33. In step S33, the recording/reproducing apparatus displays an error message to indicate that the entered broadcast cannot be programmed for recording, and then terminates the process.

As described above, the recording/reproducing apparatuses in the past judge, at the time of programming a broadcast for recording, whether a tuner is available during a particular broadcast time slot no matter whether the apparatuses have one or two built-in tuners.

In recent years, personal computers incorporating a tuner have become widespread. Further, a large number of external tuners and board-type (PC card) tuners have been manufactured. Moreover, an additional tuner can be incorporated into a personal computer having a built-in tuner to simultaneously record a plurality of broadcasts.

### SUMMARY OF THE INVENTION

In a situation where the number of available tuners changes as described above, the programmed recording processes in the past indicated in FIGS. 1 and 3 do not effectively record broadcasts at all times.

More specifically, even if an additional tuner is installed later in a situation where no tuner was available for programmed recording when a desired broadcast was programmed for recording, the desired broadcast will not be recorded although a tuner is now available for programmed recording during a designated broadcast time slot.

The present invention has been made under the above circumstances and makes it possible to effectively use available tuners.

According to an embodiment of the present invention, there is provided an information processing apparatus for controlling an operation that is performed to record a broadcast received by a tuner onto a recording medium. The information processing apparatus includes: storage means configured to store a list of recording candidate broadcasts, which are to be recorded onto the recording medium; decision means that, at a recording start time for a particular recording candidate broadcast, which is one of the recording candidate broadcasts in the list, judges whether a tuner is available for recording the particular recording candidate broadcast, and decides whether or not to record the particular recording candidate broadcast; and recording control means configured to record the particular recording candidate broadcast onto the recording medium when a decision is made to record the particular recording candidate broadcast.

When at least part of the recording time slots of recording candidate broadcasts in the list clashes with the recording time slot of the particular recording candidate broadcast, the decision means may compare the number of tuners available for recording against the number of clashing recording candidate broadcasts, and judge whether a tuner is available for recording the particular recording candidate broadcast.

The list contains at least the priorities of the recording candidate broadcasts. When the number of clashing recording candidate broadcasts is larger than the number of tuners available for recording, the decision means may further judge the priority of the particular recording candidate broadcast and decide whether or not to record the particular recording candidate broadcast.

The information processing apparatus may further include communication means that communicates with an apparatus connected to the information processing apparatus in compliance with the DLNA (Digital Living Network Alliance) guideline.

The information processing apparatus may further include: acquisition means configured to acquire the number of tuners connected to the information processing apparatus; and registration control means configured to control a registration process that is performed to register a new recording candidate broadcast in the list. When at least part of the recording time slot of the new recording candidate broadcast clashes with the recording time slots of the recording candidate broadcasts in the list and the number of clashing recording candidate broadcasts is larger than the number of tuners connected to the information processing apparatus, the registration control means may issue a warning and register the new recording candidate broadcast in the list.

The information processing apparatus may further includes: acquisition means configured to acquire the number of tuners connected to the information processing apparatus; and registration control means configured to control a registration process that is performed to register a new recording candidate broadcast in the list. When at least part of the recording time slot of the new recording candidate broadcast clashes with the recording time slots of the recording candidate broadcasts in the list and the number of clashing recording candidate broadcasts is larger than the number of tuners connected to the information processing apparatus, the registration control means may refrain from registering the new recording candidate broadcast in the list.

According to an embodiment of the present invention, there is provided an information processing method for use in an information processing apparatus for controlling an operation that is performed to record a broadcast received by a tuner onto a recording medium. The information processing method includes the steps of: judging, at a recording start time for a particular recording candidate broadcast, which is one of recording candidate broadcasts in a list that are to be recorded onto the recording medium, whether a tuner is available for recording the particular recording candidate broadcast, and deciding whether or not to record the particular recording candidate broadcast; and recording the particular recording candidate broadcast onto the recording medium when a decision is made to record the particular recording candidate broadcast.

According to an embodiment of the present invention, there is provided a program for causing a computer to control an operation that is performed to record a broadcast received by a tuner onto a recording medium. The program includes the steps of: judging, at a recording start time for a particular recording candidate broadcast, which is one of recording candidate broadcasts in a list that are to be recorded onto the recording medium, whether a tuner is available for recording the particular recording candidate broadcast, and deciding whether or not to record the particular recording candidate broadcast; and recording the particular recording candidate broadcast onto the recording medium when a decision is made to record the particular recording candidate broadcast.

An embodiment of the present invention judges, at a recording start time for a particular recording candidate broadcast, which is one of recording candidate broadcasts in a list that are to be recorded onto the recording medium, whether a tuner is available for recording the particular recording candidate broadcast, and records the particular recording candidate broadcast onto the recording medium when a decision is made to record the particular recording candidate broadcast.

An embodiment of the present invention makes it possible to effectively use available tuners.

### BRIEF DESCRIPTION OF THE DRAWINGS

FIG. 1 is a flowchart illustrating a programmed recording process in the past;

FIG. 2 is a flowchart illustrating a recording execution process in the past;

FIG. 3 is a flowchart illustrating another programmed recording process in the past;

FIG. 4 is a block diagram illustrating an information processing system according to an embodiment of the present invention;

FIG. 5 is a block diagram illustrating a typical hardware configuration of a content recording/reproducing apparatus;

FIG. 6 is a block diagram illustrating a typical hardware configuration of a main control section;

FIG. 7 is a block diagram illustrating a typical hardware configuration of a content recording section;

FIG. 8 is a block diagram illustrating a typical hardware configuration of an external tuner;

FIG. 9 is a block diagram illustrating a typical hardware configuration of a notebook PC;

FIG. 10 illustrates communication that is based on a protocol defined by the DLNA guideline;

FIG. 11 is a block diagram illustrating a functional configuration of the information processing system shown in FIG. 4;

FIG. 12 is a flowchart illustrating a recording candidate broadcast registration process;

FIG. 13 is a flowchart illustrating a recording execution process;

FIG. 14 shows an example of a recording candidate broadcast list;

FIG. 15 illustrates the recording candidate broadcast list shown in FIG. 14;

FIG. 16 is a flowchart illustrating a priority recording execution process;

FIG. 17 is a flowchart illustrating a recording candidate broadcast registration process; and

FIG. 18 is a flowchart illustrating another recording candidate broadcast registration process.

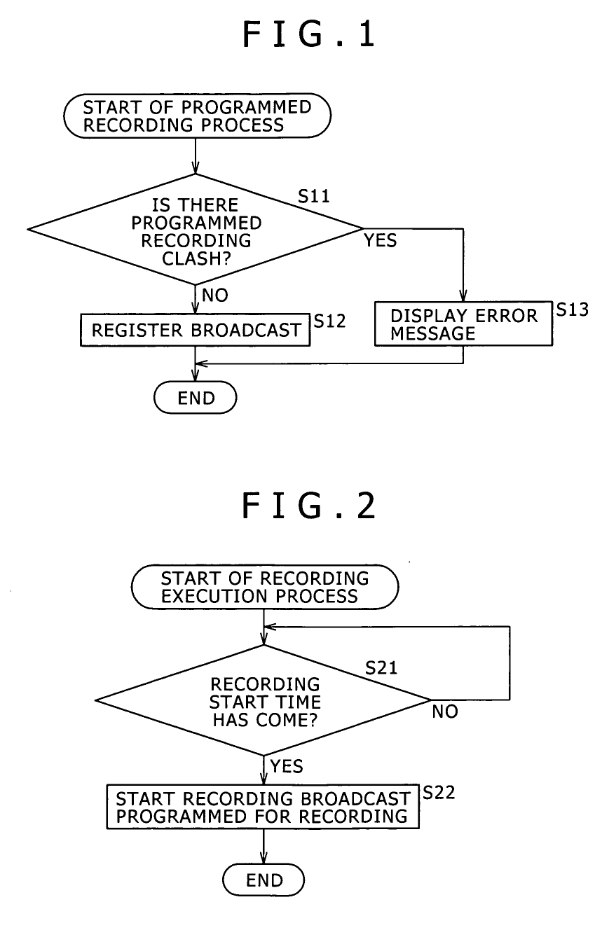

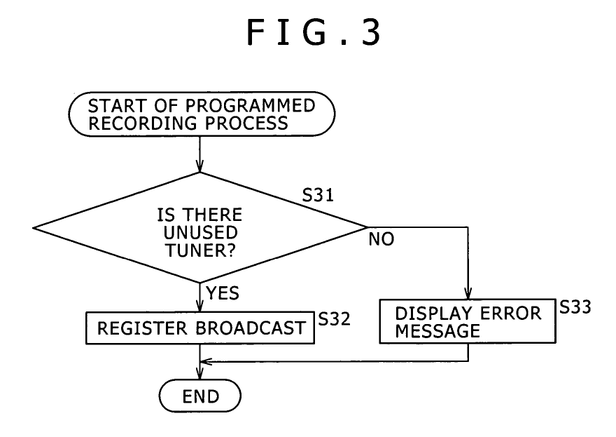

### DETAILED DESCRIPTION OF THE PREFERRED EMBODIMENTS

Embodiments of the present invention will now be described. The relationship between the constituent features of the present invention and the embodiments described under “DETAILED DESCRIPTION OF THE PREFERRED EMBODIMENTS” is exemplified below. This statement verifies that the embodiments supporting the present invention are described under “DETAILED DESCRIPTION OF THE PREFERRED EMBODIMENTS.” Therefore, even if a certain embodiment is not described here as an embodiment that corresponds to the constituent features of the present invention although the embodiment is described under “DETAILED DESCRIPTION OF THE PREFERRED EMBODIMENTS,” it does not mean that the embodiment does not correspond to the constituent features. Conversely, even if the embodiment is described here as an embodiment that corresponds to the constituent features, it does not mean that the embodiment does not correspond to the other constituent features.

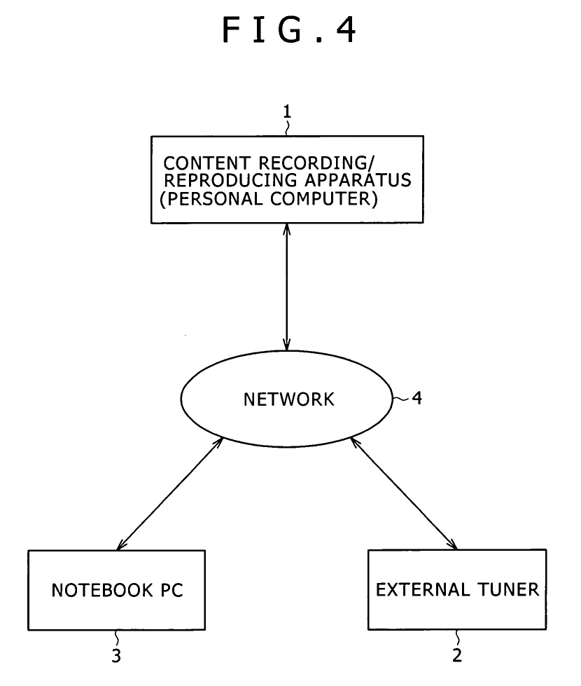

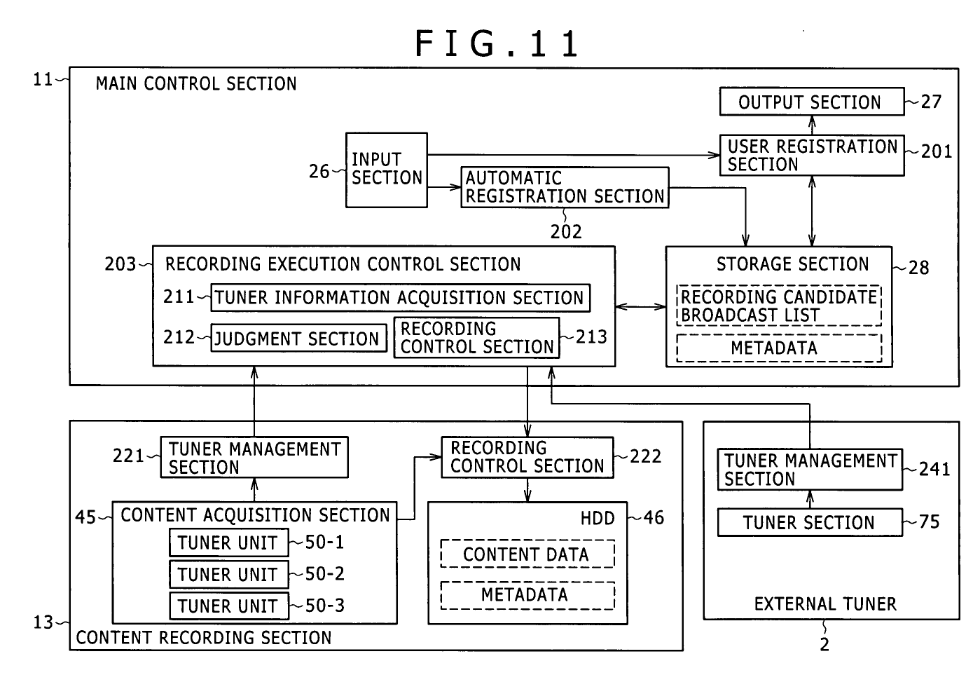

Firstly, the information processing apparatus (e.g., a content recording/reproducing apparatus 1 shown in FIG. 4) according to an embodiment of the present invention, which controls an operation that is performed to record a broadcast received by a tuner onto a recording medium, includes a storage section (e.g., a storage section 28 shown in FIG. 11) configured to store a list of recording candidate broadcasts, which are to be recorded onto the recording medium; a decision section (e.g., a judgment section 212 shown in FIG. 11) that, at a recording start time for a particular recording candidate broadcast, which is one of the recording candidate broadcasts in the list, judges whether a tuner is available for recording the particular recording candidate broadcast, and decides whether or not to record the particular recording candidate broadcast; and a recording control section (e.g., a recording control section 213 shown in FIG. 11) configured to record the particular recording candidate broadcast onto the recording medium when a decision is made to record the particular recording candidate broadcast.

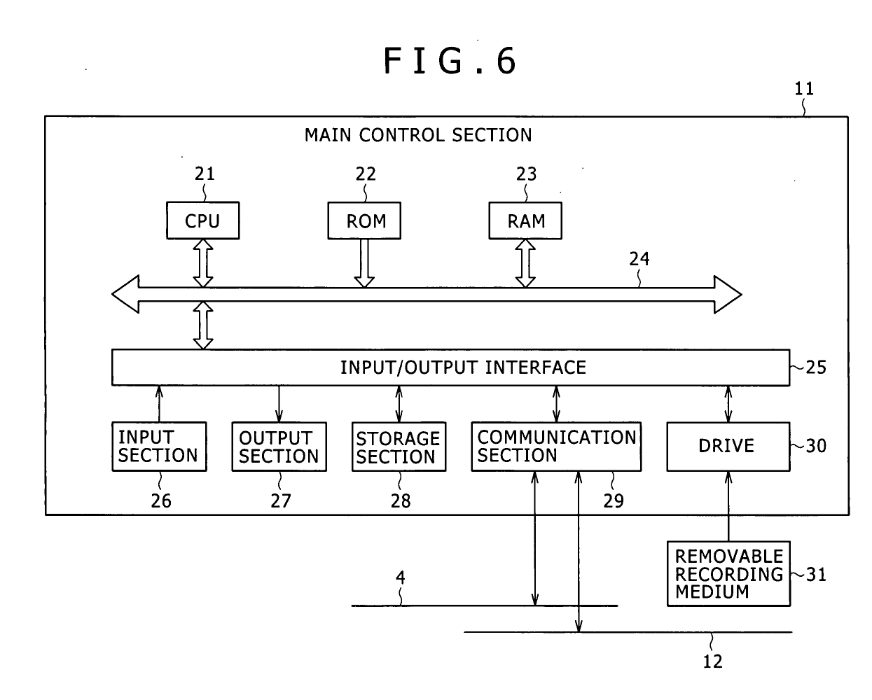

Secondly, the information processing apparatus according to an embodiment of the present invention further includes a communication section (e.g., a communication section 29 shown in FIG. 6) configured to communicate with an apparatus connected to the information processing apparatus in compliance with the DLNA (Digital Living Network Alliance) guideline.

Thirdly, the information processing apparatus according to an embodiment of the present invention further includes an acquisition section (e.g., a tuner information acquisition section 211 shown in FIG. 11) configured to acquire the number of tuners connected to the information processing apparatus; and a registration control section (e.g., a user registration section 201 shown in FIG. 11) configured to control a registration process that is performed to register a new recording candidate broadcast in the list. When at least part of the recording time slot of the new recording candidate broadcast clashes with the recording time slots of the recording candidate broadcasts in the list and the number of clashing recording candidate broadcasts is larger than the number of tuners connected to the information processing apparatus, the registration control section issues a warning and registers the new recording candidate broadcast in the list.

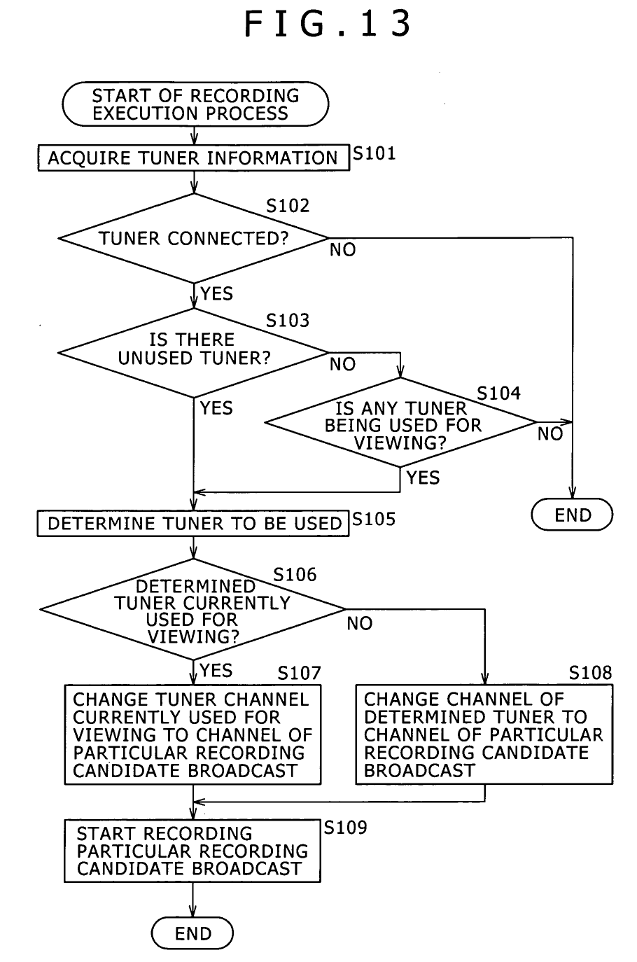

The information processing method or program according to an embodiment (first embodiment) of the present invention, which is used in an information processing apparatus for controlling an operation that is performed to record a broadcast received by a tuner onto a recording medium or causes a computer to control an operation that is performed to record a broadcast received by a tuner onto a recording medium, includes the steps of: judging, at a recording start time for a particular recording candidate broadcast, which is one of recording candidate broadcasts in a list that are to be recorded onto the recording medium, whether a tuner is available for recording the particular recording candidate broadcast, and deciding whether or not to record the particular recording candidate broadcast (e.g., step S103 in FIG. 13); and recording the particular recording candidate broadcast onto the recording medium when a decision is made to record the particular recording candidate broadcast (e.g., step S109 in FIG. 13).

Embodiments of the prevent invention will now be described with reference to the accompanying drawings.

FIG. 4 illustrates a typical configuration of an information processing system according to an embodiment of the present invention.

The information processing system shown in FIG. 4 includes a content recording/reproducing apparatus (information processing apparatus), which includes, for instance, a personal computer, an external tuner 2, a notebook PC (Personal Computer) 3, and a network 4.

The content recording/reproducing apparatus 1, external tuner 2, and notebook PC 3 are installed at a user's home so that a home network is established through the use of the network 4.

The content recording/reproducing apparatus 1 has a built-in tuner (not shown), and records broadcasts received by the tuner. In the present embodiment, recording a broadcast means recording a video signal or audio signal that constitutes the broadcast, and supplying a broadcast means supplying a video signal or audio signal that constitutes the broadcast.

The content recording/reproducing apparatus 1 accesses the notebook PC 3 and the external tuner 2 via the network 4 to ask whether a tuner is available and whether a tuner is currently used. If the notebook PC 3 and external tuner 2 includes a tuner that is available, the content recording/reproducing apparatus 1 can receive and record a broadcast received by such a tuner.

The external tuner 2 receives an electric wave corresponding to a broadcast, which is transmitted from a broadcast station in the form of a terrestrial wave or satellite wave, and transmits the electric wave to the connected apparatus, that is, the content recording/reproducing apparatus 1.

The notebook PC 3 is a mobile personal computer, which the user may carry as needed when he/she leaves home. The notebook PC 3 has a built-in tuner (not shown), and records a broadcast received by the tuner onto an incorporated recording medium. If a request is issued by the content recording/reproducing apparatus 1, which is connected via the network, while the notebook PC 3 is not using a tuner, the notebook PC 3 supplies a broadcast received by its built-in tuner to the content recording/reproducing apparatus 1.

The network 4 is a communication network that is established on the basis, for instance, of IEEE (The Institute of Electrical and Electronic Engineers) 1394, Ethernet (registered trademark), or USB (Universal Serial Bus). The network 4 is not limited to be wired. An alternative is to use, for instance, an IEEE 802.11a, IEEE 802.11b, or IEEE 802.11g wireless LAN (Local Area Network) or a Bluetooth network connect each other in wireless manner.

In the information processing system configured as described above, the content recording/reproducing apparatus 1 uses its built-in tuner to receive a broadcast that is registered (programmed) by the user, and then records it. If the tuner built in the content recording/reproducing apparatus 1 is not available, the content recording/reproducing apparatus 1 makes an inquiry to check whether the external tuner 2 connected to the network 4 is available and whether the notebook PC 3 has an available tuner. If the external tuner 2 or notebook PC tuner is available, the content recording/reproducing apparatus 1 records a broadcast that is received by the external tuner 2 or notebook PC 3.

The information exchange between the content recording/reproducing apparatus 1 and the external tuner 2 or notebook PC 3 conforms to the DLNA (Digital Living Network Alliance) guideline, which is, as described later, the specification for the digital content exchange among digital AV (Audio/Video) devices and personal computer that are interconnected to establish a home network.

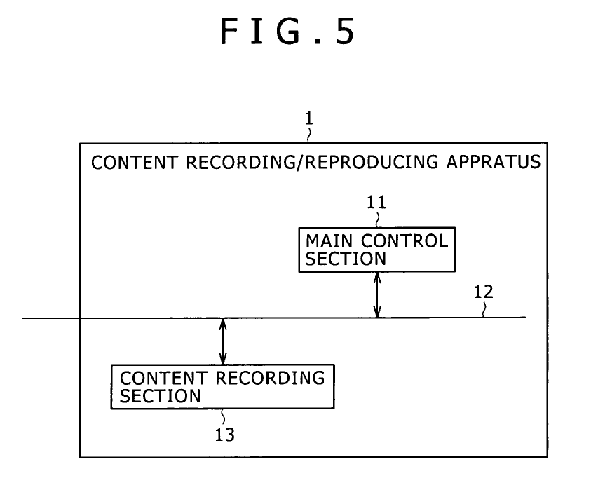

FIG. 5 is a block diagram illustrating a typical hardware configuration of the content recording/reproducing apparatus 1.

In the content recording/reproducing apparatus 1, a main control section 11 and a content recording section 13 are interconnected via a network 12 as shown in FIG. 5.

The configuration of the network 12 is not particularly defined. For example, an Ethernet (registered trademark) network may be used. Further, the network 12 is omissible. More specifically, the main control section 11 and content recording section 13 may be connected, for instance, via a bus.

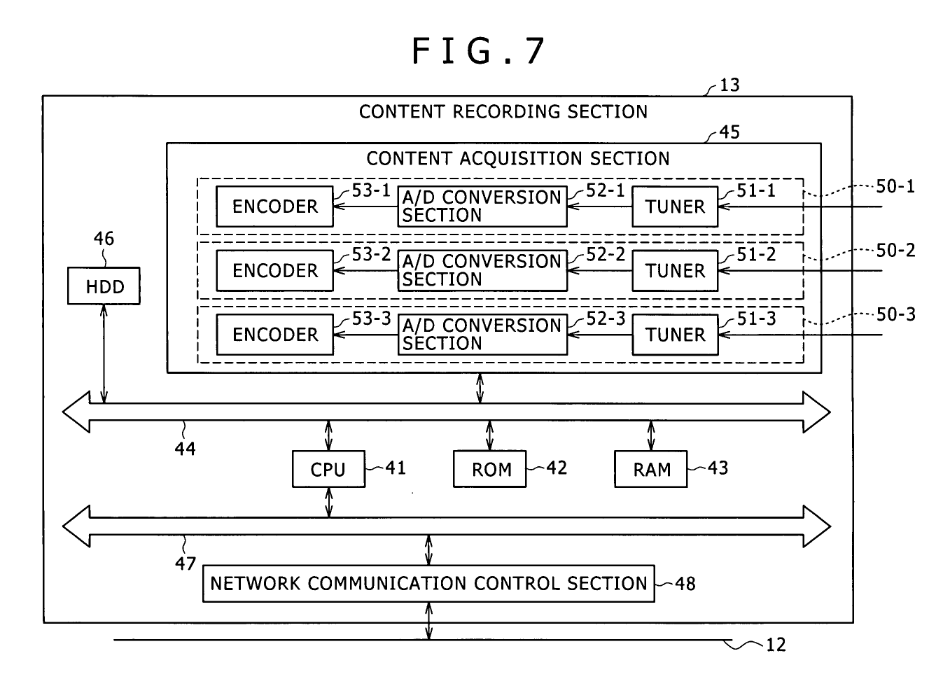

FIGS. 6 and 7 show the details of typical hardware configurations of the main control section 11 and content recording section 13. The details of typical hardware configurations of the main control section 11 and content recording section 13 will now be described in the order named with reference to FIGS. 6 and 7.

First of all, a typical hardware configuration of the main control section 11 will be described below with reference to FIG. 6.

In the main control section 11 shown in FIG. 6, a CPU (Central Processing Unit) 21 performs various processes in accordance with a program stored in a ROM (Read Only Memory) 22 or a program loaded from a storage section 28 into a RAM (Random Access Memory) 23. The RAM 23 also stores data as needed to permit the CPU 21 to perform various processes.

The CPU 21, ROM 22, and RAM 23 are interconnected via a bus 24. The bus 24 is also connected to an input/output interface 25.

The input/output interface 25 is connected to an input section 26, which includes a keyboard, a mouse, a remote controller (light receptor included); an output section 27, which includes a speaker and display; a storage section 28, which includes a hard disk; and a communication section 29, which communicates with another block (content recording section 13, external tuner 2, etc.) via a network 4 or 12. For example, the communication section 29 communicates with the external tuner 2 and notebook PC 3 in compliance with the DLNA guideline.

The input/output interface 25 is also connected to a drive 30 as needed. A magnetic disk, optical disk, magneto-optical disk, semiconductor memory, or other removable recording medium 31 is inserted into the drive 30 as needed. A computer program is read from the removable recording medium and installed in the storage section 28 as needed.

The hardware configuration of the main control section 11 is not limited to the example shown in FIG. 6. Any hardware configuration may be employed for the main control section 11 as far as it agrees with the functional configuration shown in FIG. 11.

Next, a typical hardware configuration of the content recording section 13 will be described below with reference to FIG. 7.

In the content recording section 13 shown in FIG. 7, a CPU 41 performs various processes in accordance with a program stored in a ROM 42 or receives a program, which is transmitted from the main control section 11 shown in FIG. 5 via the network 12, via a network communication control section 48 and a bus 47 and loads it into a RAM 43. The CPU 41 may perform various processes in accordance with such a program. The RAM 43 also stores data as needed to permit the CPU 41 to perform various processes.

The CPU 41, ROM 42, and RAM 43 are interconnected via a bus 44. The bus 44 is also connected to a content acquisition section 45 and a HDD (Hard Disk Drive) 46.

The content acquisition section 45 is configured to simultaneously receive (acquire) various broadcasts (various pieces of content) that are broadcast during the same time slot by a plurality of broadcast stations. In the example shown in FIG. 7, the content acquisition section 45 is configured to simultaneously receive three broadcasts, which are broadcast by three broadcast stations. More specifically, the content acquisition section 45 has three tuner units 50-1 to 50-3. Tuner unit 50-1 includes a tuner 51-1, an A/D conversion section (analog-to-digital conversion section) 52-1, and an encoder 53-1. Tuner unit 50-2 includes a tuner 51-2, an A/D conversion section 52-2, and an encoder 53-2. Similarly, tuner unit 50-3 includes a tuner 51-3, an A/D conversion section 52-3, and an encoder 53-3.

The three tuner units 50-1 to 50-3 are detachable from the content recording section 13 (content recording/reproducing apparatus 1). For example, tuner unit 50-1 is initially installed in the content recording/reproducing apparatus 1, whereas tuner units 50-2 and 50-3 are later installed in the content recording/reproducing apparatus 1 by the user. Here, it is assumed that at least one tuner unit is constantly installed in the content recording/reproducing apparatus 1.

When the three tuner units 50-1 to 50-3 need not be differentiated from each other, they are hereinafter generically referred to as a tuner unit 50. Further, when the three tuners 51-1 to 51-3, the three A/D conversion sections 52-1 to 52-3, and the three encoders 53-1 to 53-3 need not be differentiated from each other, they are hereinafter generically referred to as a tuner 51, an A/D conversion section 52, and an encoder 53, respectively.

The tuner 51 demodulates a broadcast electric wave of a terrestrial or satellite broadcast that is received by an antenna (not shown), and supplies the resulting video and audio signals to the A/D conversion section 52.

More specifically, when the antenna receives the electric wave on a channel designated by the CPU 41, more precisely, the electric wave constituting a broadcast that is transmitted from a broadcast station assigned to the designated channel, the tuner 51 demodulates the received electric wave and supplies the resulting analog video signal and audio signal to the A/D conversion section 52.

The A/D conversion section 52 performs an analog-to-digital conversion process on the analog video signal and audio signal supplied from the tuner 51, and supplies the resulting digital video signal and audio signal to the encoder 53. The digital signal output from the A/D conversion section 52, that is, the digital video signal and audio signal constituting a specific broadcast, is referred to as the content data.

The encoder 53 encodes (compresses and encodes) the content data supplied from the A/D conversion section 52 by, for instance, an MPEG (Motion Picture Experts Group) 2 method, and supplies the resulting encoded content data to the CPU 41. The encoded content data output from the encoder 53 is referred to as the compressed content data.

The CPU 41 causes the HDD 46 to store the compressed content data, which is supplied from encoders 53-1 to 53-3, in the form of a file.

The HDD 46 records (stores) a broadcast (the compressed content data corresponding to a broadcast). The HDD 46 also stores the broadcast information (metadata) about a broadcast that is to be transmitted or a recorded broadcast.

The present embodiment assumes that the broadcast information about the broadcast to be transmitted is supplied from another server (not shown) that is connected to the network 4. However, the broadcast information can be acquired by any method without regard to an embodiment of the present invention. For example, the broadcast information may be extracted from the vertical blanking period of a received terrestrial television broadcast signal or from the television broadcast signal of a received satellite wave.

Meanwhile, the CPU 41 is also connected to the bus 47, which is connected to the network communication control section 48. The network communication control section 48 controls a communication process that is performed to communicate with another block (the main control section 11 in the example shown in FIG. 5) via the network 12.

The hardware configuration of the content recording section 13 is not limited to the example shown in FIG. 7. Any hardware configuration may be employed for the content recording section 13 as far as it agrees with the functional configuration shown in FIG. 11.

In the above example, it is assumed that the content recording/reproducing apparatus 1 (content recording section 13) incorporates three tuner units 50. However, any number of tuner units 50 may be incorporated in the content recording/reproducing apparatus 1. Further, the mounting positions of the tuner units 50 are not particularly defined. For example, any number of tuner units 50 may be mounted in the main control section 11.

A typical hardware configuration of the content recording/reproducing apparatus 1 has been described with reference to FIGS. 5 to 7.

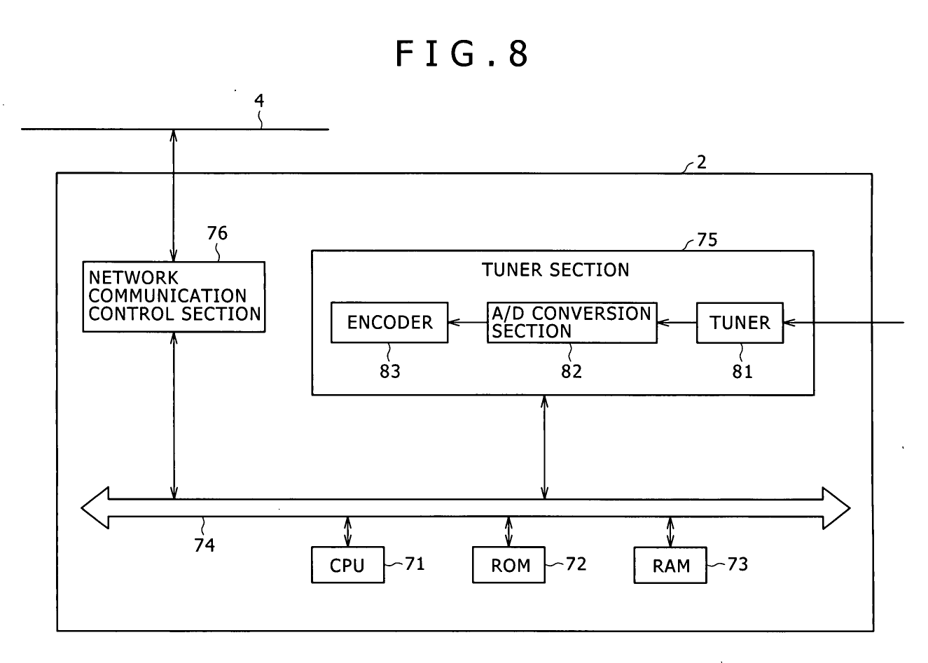

FIG. 8 is a block diagram illustrating a typical hardware configuration of the external tuner 2.

A CPU 71, a ROM 72, and a RAM 73 are interconnected via a bus 74. The bus 74 is also connected to a tuner section 75 and a network communication control section 76.

The CPU 71 performs various processes in accordance with a program stored in the ROM 72 or receives a program transmitted via the network 4 and loads it into the RAM 73 via the network communication control section 76 and bus 74. The CPU 71 may also perform various processes in accordance with such a loaded program. The RAM 73 also stores data as needed to permit the CPU 71 to perform various processes.

As is the case with the tuner units 50 described above, the tuner section 75 includes a tuner 81, an A/D conversion section 82, and an encoder 83. The tuner section 75 receives an electric wave constituting a broadcast transmitted from a broadcast station via an antenna, modulates the received electric wave, and outputs to the CPU 71 compressed content data, which is derived from MPEG2 encoding and corresponds to the broadcast.

The tuner 81, A/D conversion section 82, and encoder 83 will not be described because their functions are the same as those of the tuner 51, A/D conversion section 52, and encoder 53 of the content recording section 13 described earlier.

The network communication control section 76 establishes communication in accordance with a protocol defined by the DLNA guideline. For example, the network communication control section 76 not only receives a command transmitted from the content recording/reproducing apparatus 1 and supplies it to the CPU 71, but also receives a command and compressed content data from the CPU 71 and transmits them to the content recording/reproducing apparatus 1.

In the external tuner 2, which is configured as described above, the CPU 71 complies with a request from the content recording/reproducing apparatus 1 shown in FIG. 4 and causes the tuner section 75 to acquire a broadcast on a designated channel and transmit (supply) it to the content recording/reproducing apparatus 1.

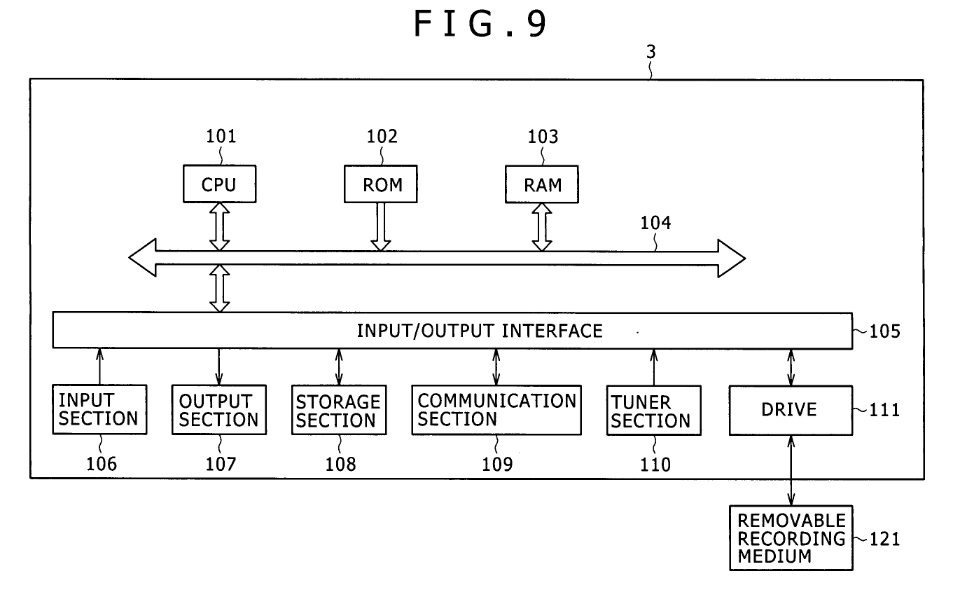

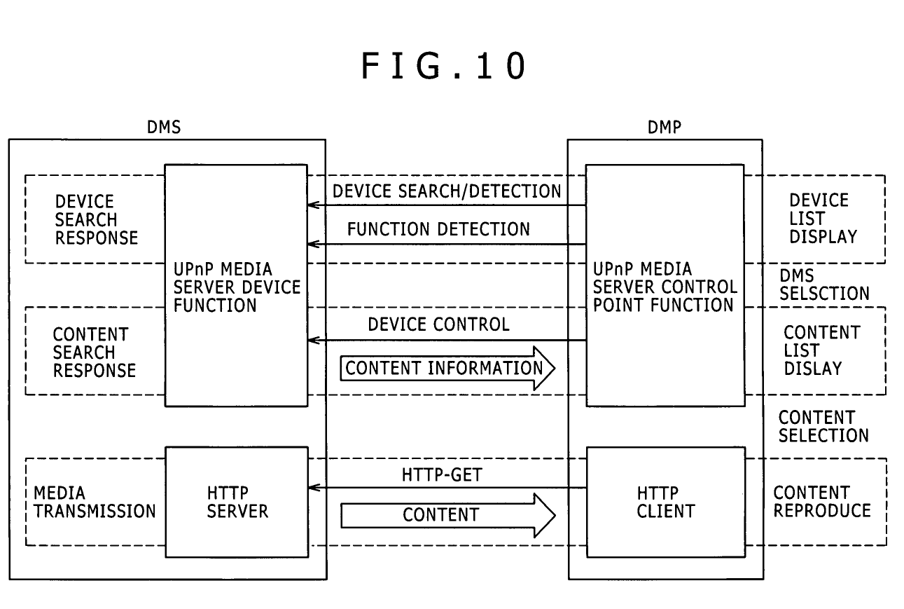

FIG. 9 is a block diagram illustrating a typical hardware configuration of the notebook PC 3.

In the notebook PC 3 shown in FIG. 9, a CPU 101 performs various processes in accordance with a program stored in a ROM 102 or a storage section 108. A RAM 103 stores as needed the program to be executed by the CPU 101 and the data handled by the CPU 101. The CPU 101, ROM 102, and RAM 103 are interconnected via a bus 104.

The CPU 101 is also connected to an input/output interface 105 via the bus 104. The input/output interface 105 is connected to an input section 106, which includes a keyboard, a mouse, and a microphone, and an output section 107, which includes an LCD (Liquid Crystal Display) or other display and speaker. The CPU 101 performs various processes in response to a command that is input from the input section 106. Further, the CPU 101 outputs the result of processing to the output section 107.

The storage section 108 connected to the input/output interface 105 includes a hard disk or the like. It stores the program to be executed by the CPU 101 and various data. The communication section 109 communicates with an external apparatus that is connected via the network 4. For example, the communication section 109 receives a command and compressed content data from the CPU 101 and transmits them to the content recording/reproducing apparatus 1 shown in FIG. 4 in accordance with a protocol defined by the DLNA guideline.

As is the case with the tuner section 75 (FIG. 8) of the external tuner 2, the tuner section 110 receives an electric wave constituting a broadcast transmitted from a broadcast station via an antenna, demodulates the received electric wave, and outputs to the CPU 101 compressed content data, which is derived from MPEG2 encoding and corresponds to the broadcast.

When a magnetic disk, optical disk, magneto-optical disk, semiconductor memory, or other removable recording medium 121 is inserted into a drive 111 that is connected to the input/output interface 105, the drive 111 drives the inserted recording medium 121 and acquires a program and data that are recorded on the recording medium 121. The acquired program and data are transferred as needed to the storage section 108 and stored. The program and data may also be acquired via the communication section 109 and stored in the storage section 108.

When the notebook PC 3, which is configured as described above, is at a user's home, it is connected to the network 4. In compliance with a request from the content recording/reproducing apparatus 1 shown in FIG. 4, the notebook PC 3 causes the tuner section 110 to acquire a broadcast on a designated channel and transmits (supplies) the broadcast to the content recording/reproducing apparatus 1.

The communication that is established among the content recording/reproducing apparatus 1, external tuner 2, and notebook PC 3 in accordance with a protocol defined by the DLNA guideline will now be described with reference to FIG. 10.

The DLNA guideline is an IP (Internet Protocol) based interconnection specification that defines a DMS (Digital Media Server) on the server side and a DMP (Digital Media Player) on the client side having a device control GUI (Graphical User Interface).

The DMP exercises a UPnP (Universal Plug and Play) media server control point function to search for and detect the DMS and confirm (determine) the functionality possessed by the DMS. The DMP can display a list of detected DMSs (devices) on a GUI.

The DMP can also control the DMS to acquire content information from the DMS and display a list of acquired pieces of content on a GUI. In compliance with a content search request from the DMP, the DMS transmits content information.

When the user confirms the content list displayed on the GUI of the DMP and selects a desired piece of content, an HTTP (HyperText Transfer Protocol) client application of the DMP transmits an “HTTP-Get” command to an HTTP server application of the DMS, and the HTTP server application of the DMS transmits content data to the HTTP client application.

In the present embodiment, the DMP shown in FIG. 10 corresponds to the content recording/reproducing apparatus 1, and the DMS corresponds to the external tuner 2 or notebook PC 3.

Namely, in the present embodiment, the content recording/reproducing apparatus 1 searches for and detects the external tuner 2 and notebook PC 3. The content recording/reproducing apparatus 1 then confirms (detects) that the external tuner 2 and notebook PC 3 have a tuner (are capable of receiving a broadcast).

Further, the content recording/reproducing apparatus 1 acquires, as needed, content information that indicates whether the tuner possessed by the external tuner 2 or notebook PC 3 is unoccupied (available). The content recording/reproducing apparatus 1 also transmits a command (HTTP-Get) to make a request for content data with a particular broadcast channel designated, and receives the compressed content data about a broadcast that is returned in response to the command.

If the main control section 11 and content recording section 13 in the content recording/reproducing apparatus 1 are connected via a bus instead of the network 12, the main control section 11 can receive a notification from an operation system, which exercises device management, to obtain the information indicating whether the tuner unit 50 is mounted/demounted and whether the tuner is unoccupied (available).

The functional configuration of the content recording/reproducing apparatus 1, external tuner 2, and notebook PC 3 that prevails when a broadcast recording process is performed in the information processing system shown in FIG. 4 will now be described with reference to FIG. 11.

Although the external tuner 2 and notebook PC 3 differ in hardware configuration, they exercise the same functions in relation to the content recording/reproducing apparatus 1. Therefore, FIG. 11 illustrates the external tuner 2 but does not show the notebook PC 3.

Since the hardware configuration of the main control section 11 in the content recording/reproducing apparatus 1 is as indicated in FIG. 6, a user registration section 201, an automatic registration section 202, and a recording execution control section 203 are configured, for instance, as application software that is executed by the CPU 21 shown in FIG. 6. In a situation where the hardware configuration of the main control section 11 differs from the one shown in FIG. 6, it goes without saying that the user registration section 201, automatic registration section 202, and recording execution control section 203 can be configured as hardware items or as combinations of software and hardware.

Similarly, the hardware configuration of the content recording section 13 in the content recording/reproducing apparatus 1 is as indicated in FIG. 7. Therefore, a tuner management section 221 and a recording control section 222 are configured, for instance, as application software that is executed by the CPU 41 shown in FIG. 7. In a situation where the hardware configuration of the content recording section 13 differs from the one shown in FIG. 7, it goes without saying that the tuner management section 221 and recording control section 222 can be configured as hardware items or as combinations of software and hardware.

Further, since the hardware configuration of the external tuner 2 is as indicated in FIG. 8, a tuner management section 241 is configured, for instance, as application software that is executed by the CPU 71 shown in FIG. 8. In a situation where the hardware configuration of the external tuner 2 differs from the one shown in FIG. 8, it goes without saying that the tuner management section 241 can be configured as a hardware item or as a combination of software and hardware.

In the notebook PC 3, the tuner management section 241 of the external tuner 2 is configured as application software that is executed by the CPU 101 shown in FIG. 9, and the tuner section 75 of the external tuner 2 corresponds to the tuner section 110.

In the main control section 11 shown in FIG. 11, the user registration section 201 controls a registration process that is performed to register in a recording candidate broadcast list the broadcast to be recorded. More specifically, the user registration section 201 causes the display of the output section 27 to open a recording registration screen for recording registration (programming). The user then views the recording registration screen and enters from the input section 26 the broadcast to be recorded (the channel, broadcast date and time, and other relevant information about the broadcast). The user registration section 201 enters the broadcast supplied from the input section 26 in the recording candidate broadcast list (the list of recording candidate broadcasts) in the storage section 28 as a recording candidate broadcast.

The operation performed by the user to view the recording registration screen and enter the broadcast to be recorded corresponds to an operation that is formerly performed to program a broadcast for recording. However, the former differs in the following respect from the latter. In the former operation, a check is performed at the time of recording broadcast programming to determine whether the entered broadcast can be recorded (the tuner for receiving the entered broadcast is available). In the recording broadcast programming operation performed by the content recording/reproducing apparatus 1, however, such a check is not performed at the time of recording broadcast programming. More specifically, the broadcast designated by the user is unconditionally entered (registered) in the recording candidate broadcast list in the storage section 28.

Therefore, it is probable that some of the recording candidate broadcasts entered in the recording candidate broadcast list in the storage section 28 may be in broadcast time slot clash with each other and cannot possibly be recorded. In that sense, user-designated broadcasts are candidate broadcasts for recording. For this reason, in the present embodiment, the screen that is opened on the display by the user registration section 201 at the time of recording broadcast programming is referred to as the recording registration screen, and the broadcast entered from the recording registration screen is referred to as a recording candidate broadcast.

The automatic registration section 202 controls an automatic registration process that is performed to automatically register (without user intervention) a recording candidate broadcast in the recording candidate broadcast list. More specifically, the automatic registration section 202 references the metadata stored in the storage section 28 and enters a broadcast, which is seemingly a user's favorite, in the recording candidate broadcast list in accordance with the keyword and other recording broadcast conditions entered from the input section 26.

As described above, the recording candidate broadcast list stores both the user-registered recording candidate broadcasts and automatically registered recording candidate broadcasts (recording candidate broadcasts registered by the content recording/reproducing apparatus 1).

The recording execution control section 203 includes a tuner information acquisition section 211, a judgment section 212, and a recording control section 213, and references the recording candidate broadcast list in the storage section 28 to exercise recording execution control.

The tuner information acquisition section 211 acquires tuner information as needed from the tuner management section 221 in the content recording section 13 or from the tuner management section 241 in the external tuner 2. More specifically, the tuner information acquisition section 211 acquires the information indicating whether a tuner is possessed by the content recording section 13 or external tuner 2 (how many tuners are possessed) and whether the tuner is currently available (unused). The tuner information acquisition section 211 also acquires the tuner information about the notebook PC 3 in the same manner.

The judgment section 212 monitors the recording candidate broadcasts registered in the recording candidate broadcast list in the storage section 28. When the recording candidate broadcast list contains a particular recording candidate broadcast whose recording start time has come (this broadcast is hereinafter referred to as the particular recording candidate broadcast), the judgment section 212 notes the tuner information acquired by the tuner information acquisition section 211, judges whether the tuner for recording the particular recording candidate broadcast is available, and decides whether or not to record the particular recording candidate broadcast. Here it is assumed that the recording start time is earlier than the broadcast start time for a recording candidate broadcast by a predetermined amount of time (e.g., five seconds).

When the judgment section 212 decides to record the particular recording candidate broadcast, the recording control section 213 supplies a control signal to the recording control section 222 in the content recording section 13 in order to record the particular recording candidate broadcast.

If one of the tuner units 50-1 to 50-3 in the content acquisition section 45 is available for recording the particular recording candidate broadcast, the recording control section 213 supplies a control signal to the recording control section 222 so that the particular recording candidate broadcast is received by one of the tuner units 50-1 to 50-3 and recorded onto the HDD 46.

If, on the other hand, the tuner section 75 in the external tuner 2 (the tuner section 110 in the notebook PC 3) is available for recording the particular recording candidate broadcast and no tuner units 50-1 to 50-3 in the content acquisition section 45 are available, the recording control section 213 causes the external tuner 2 (notebook PC 3) to receive the particular recording candidate broadcast and supply its compressed content data to the main control section 11, transfers the compressed content data to the recording control section 222 in the content recording section 13, and causes the HDD 46 to record the compressed content data.

It should be noted in this connection that the recording control section 213 can receive the particular recording candidate broadcast, which is received by the content recording section 13, external tuner 2, or notebook PC 3, via the network 12 or network 4, and cause the storage section 28 to store it.

The tuner management section 221 in the content recording section 13 supplies tuner information and particular recording candidate broadcast (its compressed content data) in compliance with a request from the recording execution control section 203. In accordance with a control signal from the recording execution control section 203, the recording control section 222 supplies the particular recording candidate broadcast acquired by the content acquisition section 45 to the HDD 46 and causes the HDD 46 to record it. Further, the recording control section 222 supplies the particular recording candidate broadcast supplied from the recording execution control section 203 to the HDD 46 and causes the HDD 46 to record it.

The tuner management section 241 in the external tuner 2 supplies tuner information and particular recording candidate broadcast (its compressed content data) to the recording execution control section 203 in compliance with a request from the recording execution control section 203.

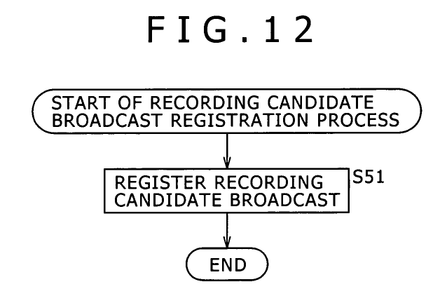

The recording candidate broadcast registration process performed by the user registration section 201 will now be described with reference to FIG. 12.

When the user views the recording registration screen displayed on the output section 27 and enters a recording candidate broadcast that is to be recorded, the user registration section 201 registers the recording candidate broadcast supplied from the input section 26 in the recording candidate broadcast list in the storage section 28, and then terminates the process.

As described above, the content recording/reproducing apparatus 1 does not check at the time of registering a desired broadcast in the recording candidate broadcast list whether a tuner is available for receiving the broadcast to be registered. Instead, the entered broadcast is registered in the recording candidate broadcast list as a recording candidate broadcast. This also holds true in a situation where the automatic registration section 202 registers a broadcast matching the keyword (recording broadcast condition) in the recording candidate broadcast list. More specifically, the broadcast matching the keyword is registered in the recording candidate broadcast list as a recording candidate broadcast without checking whether a tuner is available for receiving the broadcast to be registered.

The recording execution process (for recording the particular recording candidate broadcast) that is performed to record the particular recording candidate broadcast, which is one of the recording candidate broadcasts registered in the recording candidate broadcast list, will now be described with reference to a flowchart in FIG. 13. This process starts when a recording start time for the particular recording candidate broadcast comes.

In the first step (step S101), the tuner information acquisition section 211 acquires tuner information from the tuner management section 221 and tuner management section 241.

In step S102, the judgment section 212 notes the tuner information and judges whether a tuner is connected. Here, the tuner is the tuner unit 50 in the content recording section 13 (which includes the tuner 51), the tuner section 75 in the external tuner 2, or the tuner section 110 in the notebook PC 3. If the judgment result obtained in step S102 indicates that no tuner is connected (installed), the process terminates because no tuner is available for recording.

If, on the other hand, the judgment result obtained in step S102 indicates that a tuner is connected, processing proceeds to step S103. In step S103, the judgment section 212 judges whether there is at least one unused tuner. If the judgment result obtained in step S103 indicates that there is no unused tuner, processing proceeds to step S104. In step S104, the judgment section 212 judges whether any tuner is being used for viewing. Recording takes precedence over viewing. Therefore, if a tuner is being used for viewing, it can be used for recording.

If the judgment result obtained in step S104 indicates that no tuner is being used for viewing, the judgment section 212 terminates the process because no tuner is available for recording.

If, on the other hand, the judgment result obtained in step S104 indicates that a tuner is being used for viewing, or if the judgment result obtained in step S103 indicates that there is an unused tuner, processing proceeds to step S105. In step S105, the judgment section 212 decides to record the particular recording candidate broadcast and determines the tuner to be used. More specifically, if there is an unused tuner, the judgment section 212 performs step S105 to select that tuner as the tuner for recording the particular recording candidate broadcast. If, on the other hand, there is no unused tuner, the judgment section 212 selects a tuner that is being used for viewing as the tuner for recording the particular recording candidate broadcast.

In step S106, the recording control section 213 judges whether the tuner selected in step S105 is being used for viewing. If the judgment result obtained in step S106 indicates that the selected tuner is being used for viewing, processing proceeds to step S107. In step S107, the recording control section 213 change the channel of the tuner used for viewing to the channel for the particular recording candidate broadcast.

If, on the other hand, the judgment result obtained in step S106 indicates that the selected tuner is not being used for viewing, processing proceeds to step S108. In step S108, the recording control section 213 changes the channel of the selected tuner to the channel for the particular recording candidate broadcast.

In step S109, the recording control section 213 supplies a control signal to the recording control section 222 in the content recording section 13 to start recording the particular recording candidate broadcast. When a broadcast end time (recording end time) for the particular recording candidate broadcast comes subsequently, the recording operation that is performed by the recording control section 222 in relation to the HDD 46 terminates.

As described above, when a desired broadcast is to be registered in the recording candidate broadcast list, a check is not performed to judge whether a tuner is available for receiving the broadcast. However, when a recording start time for a recording candidate program comes, a check is performed to judge whether a tuner is available for recording. The recording candidate program is recorded by using a detected available tuner. Therefore, if, for instance, an additional tuner is installed after a desired broadcast is registered in the recording candidate broadcast list, the recording candidate broadcasts registered in the recording candidate broadcast list can be maximally recorded by using the additional tuner as well. In other words, available tuners can be effectively used.

In the above example, an unused tuner is sequentially allocated to the recording candidate broadcasts registered in the recording candidate broadcast list when their recording start time comes.

In other words, the earlier the recording start time (broadcast start time), the higher the recording priority of a recording candidate broadcast registered in the recording candidate broadcast list. The priority of a recording candidate broadcast remains unchanged no matter whether the recording candidate broadcast is registered by the user registration section 201 or by the automatic registration section 202.

However, recording candidate broadcasts registered according to a user input should generally take precedence over those which are automatically registered according to a keyword and other recording conditions.

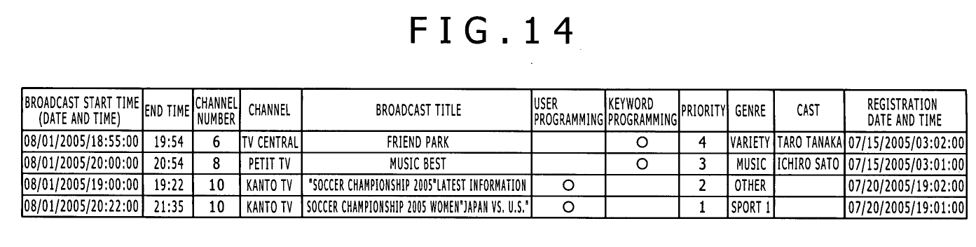

The recording execution process performed in a situation where priority setup is performed so that recording candidate broadcasts registered according to a user input take precedence over those which are automatically registered will now be described with reference to FIGS. 14 to 16.

FIG. 14 shows a typical recording candidate broadcast list that contains the priority information about recording candidate broadcasts.

The recording candidate broadcast list contains the information about the broadcast start time (date and time), end time, recording channel number, recording channel name, broadcast title, user programming (whether the registration is made according to a user input), keyword programming (whether the registration is automatically made according to a keyword), priority, genre, cast, and registration date and time of each recording candidate broadcast.

In the example shown in FIG. 14, four recording candidate broadcasts are registered in the recording candidate broadcast list. The recording candidate broadcast listing having the highest priority is titled “Soccer Championship 2005 Women ‘Japan vs. U.S.’” This recording candidate broadcast is user-registered on Jul. 20, 2005, at 19:01, is broadcast on channel 10 (Kanto TV) between Aug. 1, 2005, 20:22 and Aug. 1, 2005, 21:35, and belongs to a genre of “Sport 1.”

The recording candidate broadcast listing having the second highest priority is titled “‘Soccer Championship 2005’ Latest Information.” This recording candidate broadcast is user-registered on Jul. 20, 2005, at 19:02, is broadcast on channel 10 (Kanto TV) between Aug. 1, 2005, 19:00 and Aug. 1, 2005, 19:22, and belongs to a genre of “Other.”

The recording candidate broadcast listing having the third highest priority is titled “Music Best.” This recording candidate broadcast is keyword-registered (automatically registered) on Jul. 15, 2005, at 03:01, is broadcast on channel 8 (Petit TV) between Aug. 1, 2005, 20:00 and Aug. 1, 2005, 20:54, and belongs to a genre of “Music.”

The recording candidate broadcast listing having the fourth highest priority is titled “Friend Park.” This recording candidate broadcast is keyword-registered (automatically registered) on Jul. 15, 2005, at 03:02, is broadcast on channel 6 (TV Central) between Aug. 1, 2005, 18:55 and Aug. 1, 2005, 19:54, and belongs to a genre of “Variety.”

As regards the broadcast titled “Soccer Championship 2005 Women ‘Japan vs. U.S.’” and the broadcast titled “‘Soccer Championship 2005’ Latest Information,” which are both user-registered, the one having the earlier registration date and time is assigned the higher priority. This also holds true for the broadcast titled “Music Best” and the broadcast titled “Friend Park,” which are both keyword-registered.

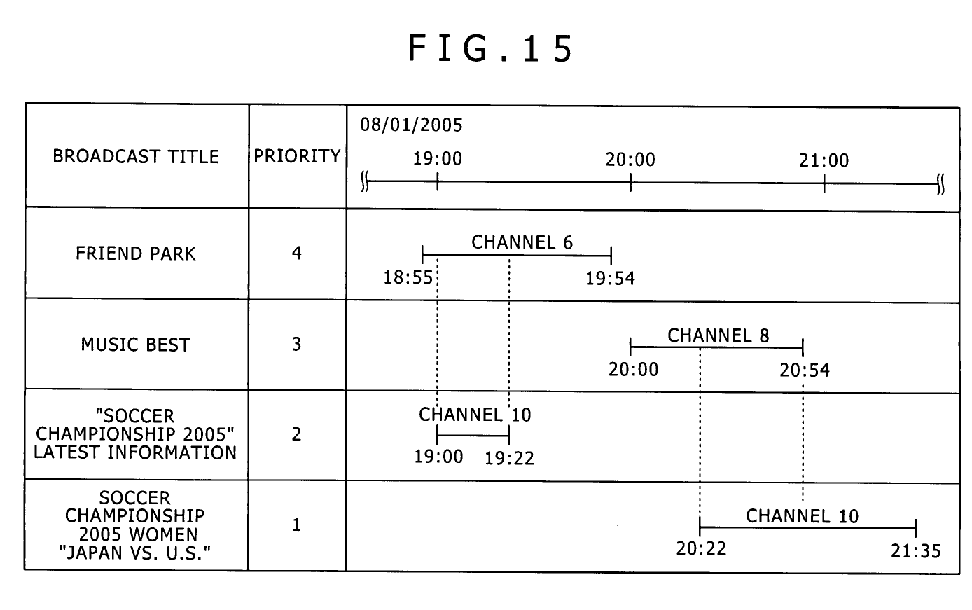

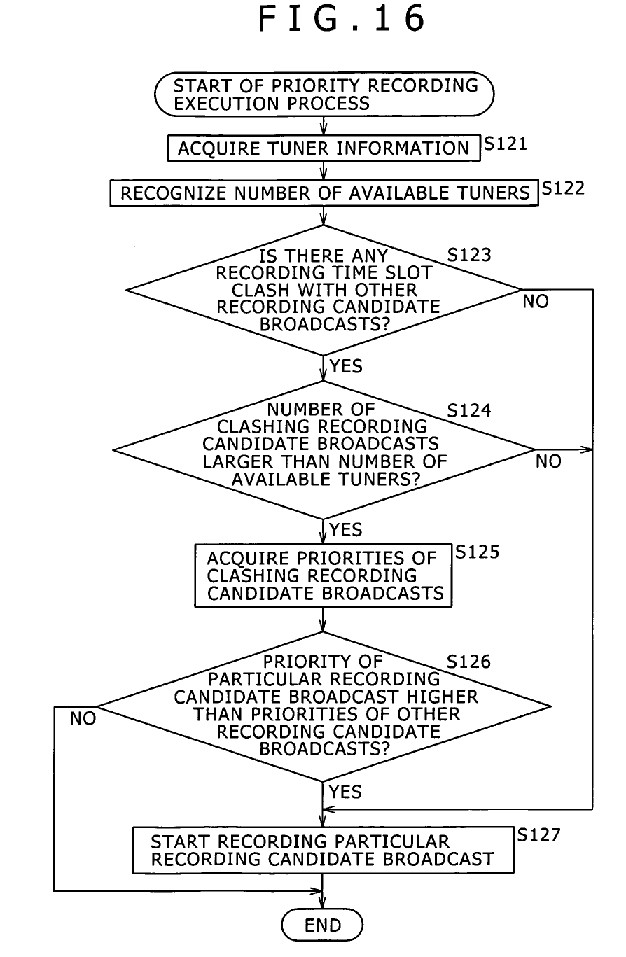

FIG. 15 is a timing diagram illustrating the recording candidate broadcasts registered in the recording candidate broadcast list shown in FIG. 14. In this timing diagram, the broadcast time is shown along the horizontal axis.

As indicated in FIG. 15, there is a registration clash between the recording candidate broadcast that is titled “‘Soccer Championship 2005’ Latest Information” and assigned the second highest priority and the recording candidate broadcast that is titled “Friend Park” and assigned the fourth highest priority. More specifically, the recording time slots of these two broadcasts clash with each other between 19:00 and 19:22.

Further, there is a registration clash between the recording candidate broadcast that is titled “Music Best” and assigned the third highest priority and the recording candidate broadcast that is titled “Soccer Championship 2005 Women ‘Japan vs. U.S.’” and assigned the highest priority. More specifically, the recording time slots of these two broadcasts clash with each other between 20:22 and 20:54.

The recording execution process to be performed to record the four recording candidate broadcasts registered in the recording candidate broadcast list shown in FIG. 14 in a situation where one tuner is available, which is the simplest situation, will now be described with reference to the timing diagram shown in FIG. 15. For the sake of simplicity, it is assumed that the recording start time is the same as the broadcast start time.

First of all, when the present time is Aug. 1, 2005, 18:55, the recording execution control section 203 detects the recording candidate broadcast titled “Friend Park.” The recording time slot for this recording candidate broadcast is from 18:55 to 19:54. As mentioned earlier, this recording candidate broadcast clashes with the recording candidate broadcast titled “‘Soccer Championship 2005’ Latest Information” during a time slot of 19:00 to 19:22.

Therefore, the judgment section 212 compares the priority of the recording candidate broadcast titled “Friend Park” and the priority of the recording candidate broadcast titled “‘Soccer Championship 2005’ Latest Information.” Since the obtained judgment result indicates that the recording candidate broadcast titled “Friend Park” has lower priority than the recording candidate broadcast titled “‘Soccer Championship 2005’ Latest Information,” the judgment section 212 decides not to record the recording candidate broadcast titled “Friend Park.” Consequently, the apparatus does not record the recording candidate broadcast titled “Friend Park.”

Next, when the present time is Aug. 1, 2005, 19:00, the recording execution control section 203 detects the recording candidate broadcast titled “‘Soccer Championship 2005’ Latest Information.” The recording time slot for this recording candidate broadcast is from 19:00 to 19:22. As mentioned earlier, this recording candidate broadcast clashes with the recording candidate broadcast titled “Friend Park” during a time slot of 19:00 to 19:22. However, since the recording candidate broadcast titled “‘Soccer Championship 2005’ Latest Information” has higher priority than the recording candidate broadcast titled “Friend Park,” the judgment section 212 decides to record the recording candidate broadcast titled “‘Soccer Championship 2005’ Latest Information.” Consequently, the apparatus records the recording candidate broadcast titled “‘Soccer Championship 2005’ Latest Information.”

Next, when the present time is Aug. 1, 2005, 20:00, the recording execution control section 203 detects the recording candidate broadcast titled “Music Best.” The recording time slot for this recording candidate broadcast is from 20:00 to 20:54. As mentioned earlier, this recording candidate broadcast clashes with the recording candidate broadcast titled “Soccer Championship 2005 Women ‘Japan vs. U.S.’” during a time slot of 20:22 to 20:54. Since the recording candidate broadcast titled “Music Best” has lower priority than the recording candidate broadcast titled “Soccer Championship 2005 Women ‘Japan vs. U.S.’,” the judgment section 212 decides not to record the recording candidate broadcast titled “‘Soccer Championship 2005’ Latest Information.”Consequently, the apparatus does not record the recording candidate broadcast titled “Music Best.”

Similarly, when the present time is Aug. 1, 2005, 20:22, the recording execution control section 203 detects the recording candidate broadcast titled “Soccer Championship 2005 Women ‘Japan vs. U.S.’” The recording time slot for this recording candidate broadcast is from 20:22 to 21:35. As mentioned earlier, this recording candidate broadcast clashes with the recording candidate broadcast titled “Music Best” during a time slot of 20:22 to 20:54. Since the recording candidate broadcast titled “Soccer Championship 2005 Women ‘Japan vs. U.S.’” has higher priority than the recording candidate broadcast titled “Music Best,” the judgment section 212 decides to record the recording candidate broadcast titled “Soccer Championship 2005 Women ‘Japan vs. U.S.’” Consequently, the apparatus records the recording candidate broadcast titled “Soccer Championship 2005 Women ‘Japan vs. U.S.’”

As described above, when the number of clashing recording candidate broadcasts (two in the example shown in FIG. 15) is larger than the number of tuners available for recording (one in the example shown in FIG. 15), the judgment section 212 judges the priority of a particular recording candidate broadcast and decides whether or not to record the particular recording candidate broadcast. More specifically, the judgment section 212 judges whether the priority of the particular recording candidate broadcast is higher than that of a clashing recording candidate broadcast whose recording time slot conflicts with the recording time slot of the particular recording candidate broadcast, and decides whether or not to record the particular recording candidate broadcast.

The priority of a recording candidate broadcast registered in the recording candidate broadcast list can be set by a first setup method (rule), which is based on the recording start time, by a second setup method (rule), which is based on automatic registration or user registration, and by various other setup methods (rules).

For example, the content recording/reproducing apparatus 1 stores the information about broadcasts that were viewed by the user. When there is a broadcast time slot clash, a third setup method may be adopted to compare the genres of various recording candidate broadcasts, determine the number of broadcasts of the same genre that were viewed by the user and the period of time during which broadcasts of the same genre were viewed by the user, and assigns a high priority to a recording candidate broadcast that was viewed frequently or for a long period of time. A fourth setup method may be adopted to compare the cast of various recording candidate broadcasts, determine the number of broadcasts involving the same cast that were viewed by the user and the period of time during which broadcasts involving the same cast were viewed by the user, and assigns a high priority to a recording candidate broadcast that was viewed frequently or for a long period of time. A fifth setup method may be adopted to compare the channels of various recording candidate broadcasts, determine the number of broadcasts on the same channel that were viewed by the user and the period of time during which broadcasts on the same channel were viewed by the user, and assigns a high priority to a recording candidate broadcast that was viewed frequently or for a long period of time.

When the third to fifth setup methods are used, the validity period for the use of previously stored information can be set. For example, the third to fifth setup methods may be adopted by using the information that was collected during the last one-month period. In this instance, the changes in the user's preference can be flexibly reflected in priority setup.

A setup method other than the first to fifth setup methods may be employed. A combination of some of the above setup methods may also be employed. When a combination of some setup methods is employed, the involved setup methods may be individually weighted. For example, a certain number of points may be provided for priority setup purposes. More specifically, the weighting method may provide three points for the priority determined according to the genre (increase the determined priority threefold), provide two points for the priority determined according to the cast (increase the determined priority twofold), and provide one point for the priority determined according to the channel (use the determined priority as is).

If, for instance, the user viewed a broadcast of the same genre as a particular recording candidate broadcast three times in the past, viewed a broadcast involving the same cast as the particular recording candidate broadcast fives times in the past, and viewed a broadcast on the same channel as the particular recording candidate broadcast one time in the past, a total of 20 points (3 (genre points)×3 (times)+2 (cast points)×5 (times)+1 (channel point)×1 (time)) are provided for the priority of the particular recording candidate broadcast.

The priority recording execution process, which is a recording execution process based on priority, will now be described with reference to a flowchart in FIG. 16. As is the case with the process indicated in FIG. 13, the priority recording execution process starts when a recording start time for a particular recording candidate broadcast comes.

In the first step (step S121), the tuner information acquisition section 211 acquires tuner information from the tuner management section 221 and tuner management section 241.

In step S122, the judgment section 212 notes the tuner information and recognizes the number of currently available tuners (the maximum number of tuners).

In step S123, the judgment section 212 judges whether the recording candidate broadcast list contains a recording candidate broadcast whose recording time slot clashes with that of the particular recording candidate broadcast. If the judgment result obtained in step S123 indicates that the recording candidate broadcast list does not contain a recording candidate broadcast whose recording time slot clashes with that of the particular recording candidate broadcast, processing skips steps S124 to S126 and proceeds to step S127.

If, on the other hand, the judgment result obtained in step S123 indicates that the recording candidate broadcast list contains a recording candidate broadcast whose recording time slot clashes with that of the particular recording candidate broadcast, processing proceeds to step S124. In step S124, the judgment section 212 judges whether the number of clashing recording candidate broadcasts is larger than the number of currently available tuners. If the judgment result obtained in step S124 indicates that the number of clashing recording candidate broadcasts is smaller than the number of currently available tuners, processing proceeds to step S127.

If, on the other hand, the judgment result obtained in step S124 indicates that the number of clashing recording candidate broadcasts is larger than the number of currently available tuners, processing proceeds to step S125. In step S125, the judgment section 212 accesses the recording candidate broadcast list and acquires the priority of a recording candidate broadcast whose recording time slot clashes with that of the particular recording candidate broadcast.

In step S126, the judgment section 212 judges whether the priority of the particular recording candidate broadcast is higher than that of the clashing recording candidate broadcast. If the judgment result obtained in step S126 indicates that the priority of the particular recording candidate broadcast is lower than that of the clashing recording candidate broadcast, the process terminates. In other words, if the priority of the particular recording candidate broadcast is lower than that of the clashing recording candidate broadcast, the apparatus does not record the particular recording candidate broadcast.

If, on the other hand, the judgment result obtained in step S126 indicates that the priority of the particular recording candidate broadcast is higher than that of the clashing recording candidate broadcast, processing proceeds to step S127. In step S127, the judgment section 212 decides to record the particular recording candidate broadcast and notifies the recording control section 213 of such a decision. The recording control section 213 supplies a control signal to the recording control section 222 in the content recording section 13 to start recording the particular recording candidate broadcast. When the broadcast end time (recording end time) for the particular recording candidate broadcast comes subsequently, the recording operation that is performed by the recording control section 222 in relation to the HDD 46 terminates.

As described above, when the recording time slot of the particular recording candidate broadcast clashes with that of another recording candidate broadcast in the recording candidate broadcast list and the number of clashing recording candidate broadcasts is larger than the number of currently available tuners, the judgment section 212 judges the priority of the particular recording candidate broadcast and decides whether or not to start a recording operation.

In the above example, the apparatus does not check for clashing recording candidate broadcasts at the time of registering a desired broadcast in the recording candidate broadcast list because it is assumed that the number of tuners available at the recording start time is unknown, as described in conjunction with the recording candidate broadcast registration process (FIG. 12). Therefore, all the recording candidate broadcasts registered in the recording candidate broadcast list will not always be recorded.

Under the above circumstances, the user registration section 201 acquires tuner information and other relevant information as needed from various sections of the recording execution control section 203. If it is anticipated at the time of registration that a desired broadcast entered from the recording registration screen may not be recorded, the user registration section 201 displays a warning message or aborts the process of making a registration in the recording candidate broadcast list and informs the user of such an abort, thereby making it possible to avoid a situation where a registered recording candidate broadcast is not actually recorded although the user has believed that its recording is done.

Desired broadcasts entered from the recording registration screen will not always be registered in the recording candidate broadcast list as described later. Therefore, such broadcasts are referred to as the to-be-registered broadcasts in marked contrast to the above-mentioned recording candidate broadcasts that will be registered without fail.

This process is performed to ensure that the broadcasts registered by the user will be properly recorded. Therefore, no problem arises if automatically registered broadcasts are not recorded. In other words, the recording candidate broadcast list assumes that user-registered recording candidate broadcasts have higher priority than automatically registered recording candidate broadcasts.

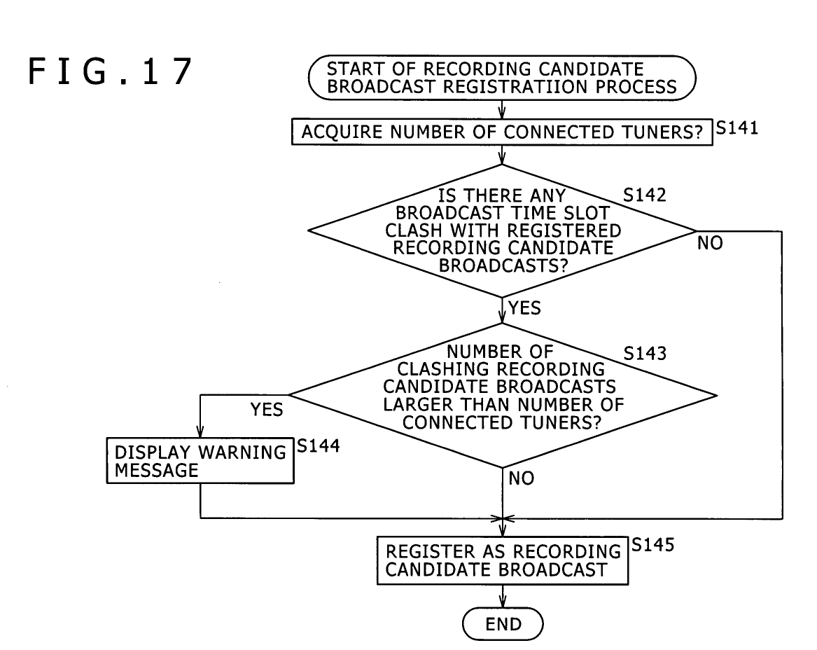

FIG. 17 is a flowchart illustrating a recording candidate broadcast registration process that is performed to display a warning message if it is anticipated at the time of registering a to-be-registered broadcast in the recording candidate broadcast list that the to-be-registered broadcast will not be recorded. As is the case with the process shown in FIG. 12, this process starts when, for instance, the user views the recording registration screen displayed on the output section 27 and enters a to-be-registered broadcast.

In the first step (step S141), the tuner information acquisition section 211 acquires tuner information from the tuner management section 221 and tuner management section 241 to determine the number of currently connected tuners.

In step S142, the judgment section 212 judges whether there is a broadcast time slot (recording time slot) clash between the to-be-registered broadcast and the recording candidate broadcasts registered in the recording candidate broadcast list.

If the judgment result obtained in step S142 indicates that the broadcast time slot (whole or part) of any recording candidate broadcast registered in the recording candidate broadcast list clashes with that of the to-be-registered broadcast, processing proceeds to step S143. In step S143, the judgment section 212 judges whether the number of clashing recording candidate broadcasts is larger than the number of connected tuners. If the judgment result obtained in step S143 indicates that the number of clashing recording candidate broadcasts is larger than the number of connected tuners, processing proceeds to step S144. In step S144, the user registration section 201 causes the display to show a warning message to indicate that the to-be-registered broadcast might not be recorded (e.g., the message “This broadcast might not be recorded”), and then proceeds to step S145.

On the other hand, if the judgment result obtained in step S143 indicates that the number of clashing recording candidate broadcasts is smaller than the number of connected tuners, or if the judgment result obtained in step S142 indicates that the broadcast time slots of the recording candidate broadcasts do not clash with the broadcast time slot of the to-be-registered broadcast, processing proceeds to step S145. In step S145, the user registration section 201 registers the to-be-registered broadcast, which is supplied from the input section 26, in the recording candidate broadcast list in the storage section 28 as a recording candidate broadcast, and then terminates the process.

As described above, in the recording candidate broadcast registration process that is performed as indicated in FIG. 17, the user registration section 201 issues a warning and registers the to-be-registered broadcast in the recording candidate broadcast list as a recording candidate broadcast when the broadcast time slot of the to-be-registered broadcast clashes with that of a recording candidate broadcast in the recording candidate broadcast list and the number of clashing recording candidate broadcasts is larger than the number of connected tuners.

When the to-be-registered broadcast is registered in step S145, the user registration section 201 assigns a lower priority to the to-be-registered broadcast than the priorities of the recording candidate broadcasts already registered in the recording candidate broadcast list. Therefore, the to-be-registered broadcast registered in step S145 can be recorded when there is an increase in the number of tuners connected to the content recording/reproducing apparatus 1 (including the tuners installed in the content recording/reproducing apparatus 1).

It is possible to open the recording candidate broadcast list, which is shown in FIG. 14, on the display, and change the priority of the to-be-registered broadcast, which is registered in step S145, and the priorities of the recording candidate broadcasts already registered in the recording candidate broadcast list.

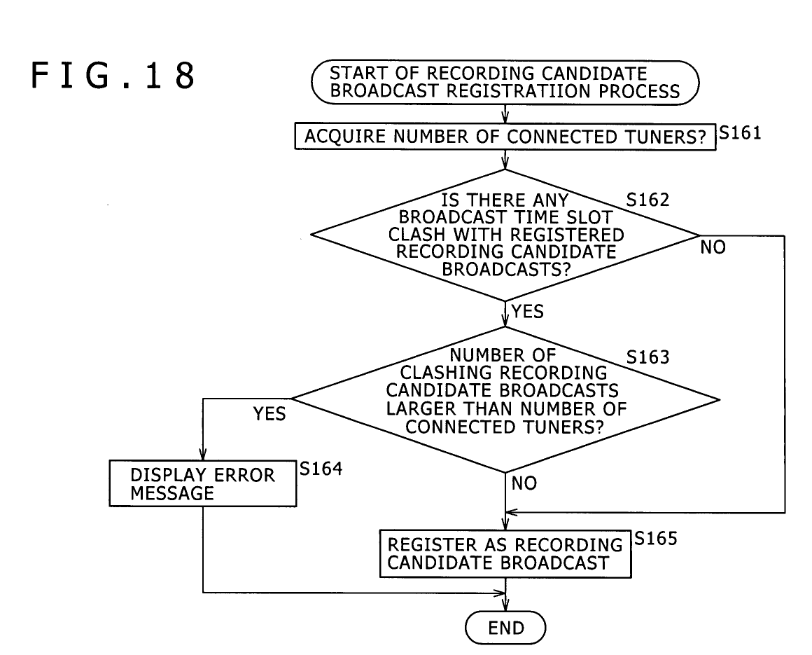

FIG. 18 is a flowchart illustrating the recording candidate broadcast registration process that is performed to refrain from registering the to-be-registered broadcast in the recording candidate broadcast list if it is anticipated at the time of registering the to-be-registered broadcast in the recording candidate broadcast list that the to-be-registered broadcast will not be recorded. This process will now be described.

In the first step (step S161), the tuner information acquisition section 211 acquires tuner information from the tuner management section 221 and tuner management section 241 to determine the number of currently connected tuners.

In step S162, the judgment section 212 judges whether there is a broadcast time slot (recording time slot) clash between the to-be-registered broadcast and the recording candidate broadcasts registered in the recording candidate broadcast list.

If the judgment result obtained in step S162 indicates that the broadcast time slot (whole or part) of any recording candidate broadcast registered in the recording candidate broadcast list clashes with that of the to-be-registered broadcast, processing proceeds to step S163. In step S163, the judgment section 212 judges whether the number of clashing recording candidate broadcasts is larger than the number of connected tuners. If the judgment result obtained in step S163 indicates that the number of clashing recording candidate broadcasts is larger than the number of connected tuners, processing proceeds to step S164. In step S164, the user registration section 201 causes the display to show a message to indicate that the to-be-registered broadcast cannot be registered (e.g., the message “Nonrecordable”), and then terminates the process.

On the other hand, if the judgment result obtained in step S163 indicates that the number of clashing recording candidate broadcasts is smaller than the number of connected tuners, or if the judgment result obtained in step S162 indicates that the broadcast time slots of the recording candidate broadcasts do not clash with the broadcast time slot of the to-be-registered broadcast, processing proceeds to step S165. In step S165, the user registration section 201 registers the to-be-registered broadcast, which is supplied from the input section 26, in the recording candidate broadcast list in the storage section 28 as a recording candidate broadcast, and then terminates the process.

As described above, in the recording candidate broadcast registration process that is shown in FIG. 18, the user registration section 201 does not register the to-be-registered broadcast in the recording candidate broadcast list when the broadcast time slot of the to-be-registered broadcast clashes with that of a recording candidate broadcast in the recording candidate broadcast list and the number of clashing recording candidate broadcasts is larger than the number of connected tuners.

In both of the recording candidate broadcast registration processes shown in FIGS. 17 and 18, if, at a certain time, the number of available tuners is larger than the number of recording candidate broadcasts that are user-registered in the recording candidate broadcast list and there is an automatically registered recording candidate broadcast, the recording candidate broadcast that is automatically registered in the recording candidate broadcast will also be recorded as a matter of course.

As described above, the information processing system shown in FIG. 4 does not judge the possibility of recording at the time when a desired broadcast is programmed (registered) for recording. Instead, it judges the possibility of recording at the time when the desired broadcast is to be recorded. Therefore, if a tuner available for recording is added (installed or connected) after broadcast programming (registration), it can be effectively used.

The information processing system shown in FIG. 4 has been described on the assumption that the content recording/reproducing apparatus 1, which exercises tuner management, is connected to the external tuner 2 and notebook PC 3 that are devices having a tuner function. However, the same processing operations can be performed even when the content recording/reproducing apparatus 1 is connected to some other device having a tuner function, such as a hard disk recorder, DVD recorder, or TV receiver. When, in such an instance, the connected devices communicate with each other in accordance with a protocol defined by the DLNA guideline, it is possible to check for connected or installed tuners and available tuners and supply content data.

The communication among the devices may be based on a unique protocol in addition to a protocol defined by the DLNA guideline. However, it is preferred that a standardized protocol be used to construct a network for a variety of devices.

The above example has been described on the assumption that a broadcast containing both video and audio is to be recorded onto a recording medium. However, the same process can be performed even when a broadcast containing either video or audio is to be recorded onto a recording medium.

When a series of processes described above is to be performed by software, the programs constituting the software are installed from a network or recording medium onto a computer built in dedicated hardware or a general-purpose personal computer or the like that can exercise various functions when various programs are installed.

The recording medium is not only the removable recording medium 31 shown in FIG. 6, such as a magnetic disk (floppy disk included), optical disk (CD-ROM (Compact Disk-Read Only Memory) and DVD (Digital Versatile Disk) included), magneto-optical disk, or semiconductor memory, which records a program and is distributed separately from the apparatus main body to supply the program to the user, but also the ROM 22 shown in FIG. 6, ROM 42 shown in FIG. 7, or a hard disk contained in the storage section 28 shown in FIG. 6 or in the HDD 46 shown in FIG. 7, which records a program and is built in the apparatus main body before being supplied to the user.

The steps indicated in the flowcharts shown in this document not only include processes that are performed in a described chronological order but also include processes that are performed parallelly or individually and not necessarily in chronological order.

In this document, the term “system” denotes the whole apparatus that includes a plurality of devices.

While the present invention has been described in terms of preferred embodiments, it should be understood that the invention is not limited to the foregoing preferred embodiments, and that variations may be made without departure from the scope and spirit of the invention.

What is claimed is:

1. An information processing apparatus for controlling an operation that is performed to record a broadcast received by a tuner onto a recording medium, the information processing apparatus comprising:
storage means configured to store a list of recording candidate broadcasts, which are to be recorded onto the recording medium;
decision means that, at a recording start time for a particular recording candidate broadcast, which is one of the recording candidate broadcasts in the list, judges whether a tuner is available for recording the particular recording candidate broadcast, and decides whether or not to record the particular recording candidate broadcast; and
recording control means configured to record the particular recording candidate broadcast onto the recording medium when a decision is made to record the particular recording candidate broadcast.

2. The information processing apparatus according to claim 1, wherein, when at least part of the recording time slots of recording candidate broadcasts in the list clashes with the recording time slot of the particular recording candidate broadcast, the decision means compares the number of tuners available for recording against the number of clashing recording candidate broadcasts, and judges whether a tuner is available for recording the particular recording candidate broadcast.

3. The information processing apparatus according to claim 2, wherein:
the list contains at least the priorities of the recording candidate broadcasts; and
when the number of clashing recording candidate broadcasts is larger than the number of tuners available for recording, the decision means further judges the priority of the particular recording candidate broadcast and decides whether or not to record the particular recording candidate broadcast.

4. The information processing apparatus according to claim 1, further comprising:
communication means configured to communicate with an apparatus connected to the information processing apparatus in compliance with the DLNA (Digital Living Network Alliance) guideline.

5. The information processing apparatus according to claim 1, further comprising:
acquisition means configured to acquire the number of tuners connected to the information processing apparatus; and
registration control means configured to control a registration process that is performed to register a new recording candidate broadcast in the list,
wherein, when at least part of the recording time slot of the new recording candidate broadcast clashes with the recording time slots of the recording candidate broadcasts in the list and the number of clashing recording candidate broadcasts is larger than the number of tuners connected to the information processing apparatus, the registration control means issues a warning and registers the new recording candidate broadcast in the list.

6. The information processing apparatus according to claim 1, further comprising:
acquisition means configured to acquire the number of tuners connected to the information processing apparatus; and
registration control means configured to control a registration process that is performed to register a new recording candidate broadcast in the list,
wherein, when at least part of the recording time slot of the new recording candidate broadcast clashes with the recording time slots of the recording candidate broadcasts in the list and the number of clashing recording candidate broadcasts is larger than the number of tuners connected to the information processing apparatus, the registration control means does not register the new recording candidate broadcast in the list.

7. An information processing method for use-in an information processing apparatus for controlling an operation that is performed to record a broadcast received by a tuner onto a recording medium, the information processing method comprising the steps of:
judging, at a recording start time for a particular recording candidate broadcast, which is one of recording candidate broadcasts in a list that are to be recorded onto the recording medium, whether a tuner is available for recording the particular recording candidate broadcast, and deciding whether or not to record the particular recording candidate broadcast; and
recording the particular recording candidate broadcast onto the recording medium when a decision is made to record the particular recording candidate broadcast.

8. A program for causing a computer to control an operation that is performed to record a broadcast received by a tuner onto a recording medium, the program comprising the steps of:
judging, at a recording start time for a particular recording candidate broadcast, which is one of recording candidate broadcasts in a list that are to be recorded onto the recording medium, whether a tuner is available for recording the particular recording candidate broadcast, and deciding whether or not to record the particular recording candidate broadcast; and
recording the particular recording candidate broadcast onto the recording medium when a decision is made to record the particular recording candidate broadcast.

9. An information processing apparatus for controlling an operation that is performed to record a broadcast received by a tuner onto a recording medium, the information processing apparatus comprising:
a storage section configured to store a list of recording candidate broadcasts, which are to be recorded onto the recording medium;
a decision section that, at a recording start time for a particular recording candidate broadcast, which is one of the recording candidate broadcasts in the list, judges whether a tuner is available for recording the particular recording candidate broadcast, and decides whether or not to record the particular recording candidate broadcast; and
a recording control section configured to record the particular recording candidate broadcast onto the recording medium when a decision is made to record the particular recording candidate broadcast.
